(19) United States
(12) Patent Application Publication
(10) Pub. No.: US 2008/0204956 A1
(43) Pub. Date: Aug. 28, 2008

(54) Override protection circuit device

(75) Inventor: Tang-Yueh Hung, Wu Fong Hsiang (TW)

Correspondence Address: TROXELL LAW OFFICE PLLC, SUITE 1404, 5205 LEESBURG PIKE, FALLS CHURCH, VA, 22041, US

(73) Assignee: Zing Ear Enterprise Co., Ltd.

(21) Appl. No.: 11/711,149

(22) Filed: Feb. 27, 2007

(51) Int. Cl. H02H 3/20

(52) U.S. Cl. 361/91.1

(57) ABSTRACT

An override protection circuit device including an operation unit, a rectifying/stabilizing unit, a load voltage sampling unit, a relay and an auto-detecting/activating unit. The operation unit includes a comparator and a standard comparison voltage. The load voltage sampling unit has a voltage-dividing sampling section for obtaining a load sampling voltage from the circuit and outputting the load sampling voltage to the comparator. The comparator compares the load sampling voltage with the standard comparison voltage so as to judge whether the load power exceeds the nominal value. In the case that the load sampling voltage is smaller than the standard comparison voltage, the comparator works normally and the relay is kept switched on. In the case that the load sampling voltage is higher than the standard comparison voltage, the comparator is in an override state to switch off the relay. In the case of override, the auto-detecting/activating unit will automatically operate to restore the comparator from the override state into the normal working state. In the case that the override state is not obviated, the auto-detecting/activating unit will periodically operate to make the load bulb regularly flicker.

### BACKGROUND OF THE INVENTION

The present invention is related to an override protection circuit device, and more particularly to an override protection circuit device for restricting the power of the bulb. In the case that the load power of a bulb exceeds a nominal value, the circuit device provides an override protection effect to automatically cut off the load circuit. In addition, the circuit device will remind a user to replace the bulb or lower the load power.

It is know that the domestic AC power has nominal voltage. The higher the power of the used bulb is, the more the consumed energy is.

In order to save energy, most people are willing to use those bulbs of smaller power, for example, under 190 wattages. In some countries, it is even regulated or encouraged to use small-power illuminators. However, due to negligence, in some cases, large-power bulbs will still be used. This leads to waste of energy. In order to solve this problem, it is tried by the applicant to provide a measure for a user to easily judge whether the load power of the bulb exceeds the nominal value.

### SUMMARY OF THE INVENTION

It is therefore a primary object of the present invention to provide an override protection circuit device set with a nominal value. A user can easily judge whether the load power of the bulb exceeds the nominal value.

It is a further object of the present invention to provide the above override protection circuit device, whereby in the case that the load power of a bulb exceeds the nominal value, the circuit device will remind a user to replace the bulb or lower the load power of the bulb.

The present invention can be best understood through the following description and accompanying drawings wherein:

### BRIEF DESCRIPTION OF THE DRAWINGS

FIG. 1 is a circuit diagram of a preferred embodiment of the present invention;

FIG. 2 is a perspective view of an override protection switch equipped with the circuit device of the present invention;

FIG. 3 is a perspective exploded view according to FIG. 2;

FIG. 4 is a perspective view of another override protection switch equipped with the circuit device of the present invention; and

FIG. 5 is a perspective exploded view according to FIG. 4.

### DETAILED DESCRIPTION OF THE PREFERRED EMBODIMENTS

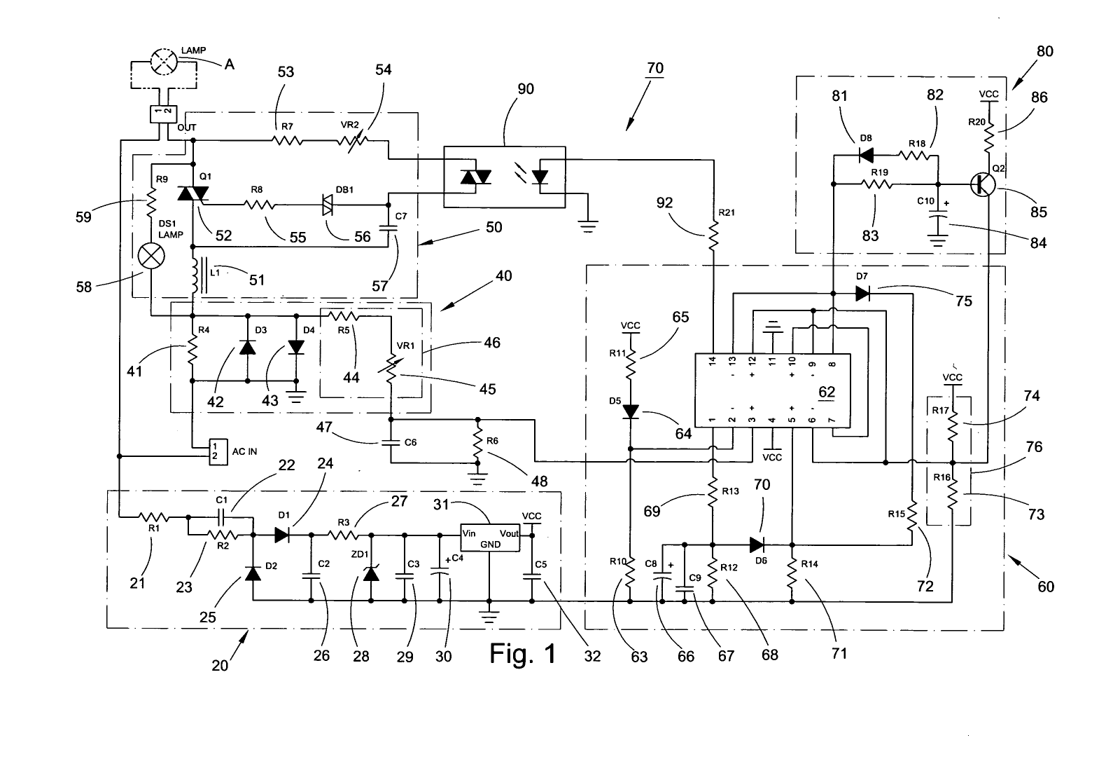

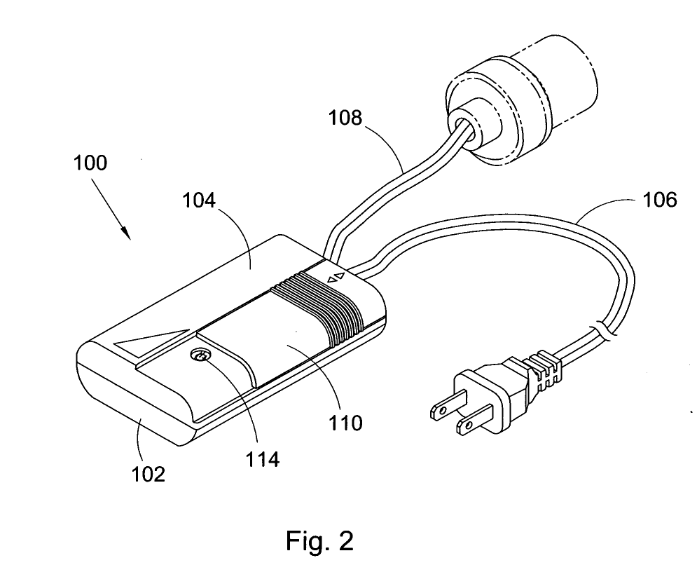

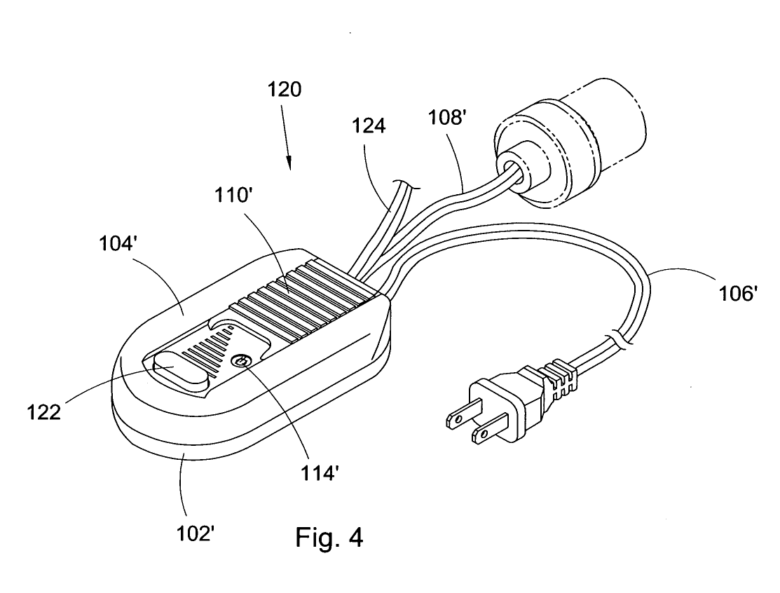

Please refer to FIG. 1 which is a circuit diagram of the circuit device 10 of the present invention. The circuit device 10 can be assembled into the override protection switch as shown in FIG. 2 or FIG. 4.

The circuit device 10 includes a rectifying/stabilizing unit 20, a load voltage sampling unit 40, a light-modulation control unit 50, an operation unit 60, an auto-detecting/activating unit 80 and a relay 90.

The operation unit 60 includes an IC comparator 62. In this embodiment, the IC comparator 62 is an IC under Model No. LM324. However, the IC comparator 62 is not limited to this Model and can be any other equivalent IC. The comparator 62 has 14 contacts and four inbuilt operation amplifiers. The contacts 2 and 3 are the input terminals of the first set of operation amplifier, while the contact 1 is the output terminal thereof. The contacts 5 and 6 are the input terminals of the second set of operation amplifier, while the contact 7 is the output terminal thereof. The contacts 9 and 10 are the input terminals of the third set of operation amplifier, while the contact 8 is the output terminal thereof. The contacts 12 and 13 are the input terminals of the fourth set of operation amplifier, while the contact 14 is the output terminal thereof.

The rectifying/stabilizing unit 20 includes a first resistor 21, a first capacitor 22, a second resistor 23, a first diode 24, a second diode 25, a second capacitor 26, a third resistor 27, a Zener diode 28, a third capacitor 29, a fourth capacitor 30, a three-terminal regulator (three-terminal regulating IC) 31 and a fifth capacitor 32. The input terminal of the rectifying/stabilizing unit 20 is connected to an AC power source. The output terminal of the rectifying/stabilizing unit 20 is connected to the operation unit 60. The AC power is rectified, filtered and stabilized by the rectifying/stabilizing unit 20 into 12V DC voltage as the necessary working voltage. The three-terminal regulator 31 serves to ensure that the voltage of the output terminal keeps stable so as to provide vcc and other circuits with necessary high-precision voltage standard.

The load voltage sampling unit 40 is connected to the AC power source and is composed of a fourth resistor 41, a third diode 42, a fourth diode 43, a fifth resistor 44 and a first variable resistor 45. In loaded state, the fourth resistor 41 provides a pull-down effect. The third and fourth diodes 42, 43 provide great current protection effect to avoid too great leakage. The fifth resistor 44 and the first variable resistor 45 together form a voltage-dividing sampling section 46 for obtaining a load sampling voltage. The value of the load sampling voltage is adjustable by means of the variable resistor 45. For example, the voltage can be adjusted to 160 W, 180 W or 200 W. The output terminal of the sampling unit 40 is connected to the contact 3 of the comparator 62 of the operation unit 60, which is the positive electrode input terminal of the first set of operation amplifier.

A sixth capacitor 47 and a sixth resistor 48 parallelly connected with the sixth capacitor 47 are connected between the voltage-dividing sampling section 46 of the sampling unit 40 and the comparator 62 of the operation unit 60 to provide a filtering effect for the sampling unit 40 so as to avoid mis-operation caused by poor signals.

One terminal of the light modulation control unit 50 is connected to the load voltage sampling unit 40, while the other terminal of the light modulation control unit 50 is connected to the output terminal of the circuit device, that is, the load bulb as shown by the phantom line A. The light modulation control unit 50 includes an inductor 51, a triac 52, a seventh resistor 53, a second variable resistor 54, an eighth resistor 55, a diac 56 and a seventh capacitor 57. An indicator lamp (a neon lamp in this embodiment) 58 and a ninth resistor 59 are parallelly connected between two terminals of the triac 52. When adjusting the variable resistor 54, the output power of the circuit is adjustable. The function of the light modulation control unit 50 will be further described hereinafter.

Besides the comparator 62, the operation unit 60 further includes a tenth resistor 63, a fifth diode 64, an eleventh resistor 65, an eighth capacitor 66, a ninth capacitor 67, a twelfth resistor 68, a thirteenth resistor 69, a sixth diode 70, a fourteenth resistor 71, a fifteenth resistor 72, a sixteenth resistor 73, a seventeenth resistor 74 and a seventh diode 75. Many electronic elements of the operation unit 60 provide basic functions so as to eliminate ripple interference, wave current, etc. These will not be further described hereinafter. The sixteenth and seventeenth resistors 73, 74 are serially connected. The contact between the two resistors 63, 64 serves as a standard comparison voltage 76. The value of the standard comparison voltage 76 is compared with the sampling voltage of the voltage-dividing sampling section 46 of the sampling unit 40. The standard comparison voltage 76 is connected to the contacts 2, 6, 9 and 12 of the comparator 62. The positive electrode of the sixth diode 70 is connected to the contact 1 of the comparator 62, while the negative electrode of the sixth diode 70 is connected to the contact 5 of the comparator 62. The polarity of the seventh diode 75 is reverse to the sixth diode 70. The positive electrode of the seventh diode 75 is connected to the contacts 8 and 13 of the comparator 52, while the negative electrode of the seventh diode 75 is connected to the contact 5 of the comparator 62 to provide a feedback effect. The fifth diode 64 and the eleventh resistor 65 are connected to the contact 2 of the comparator 62.

The auto-detecting/activating unit 80 is connected to the operation unit 60. Two terminals of the auto-detection activating unit 80 are respectively connected to the contacts 6, 8 of the comparator 62. The auto-detecting/activating unit 80 includes an eighth diode 81, an eighteenth resistor 82, a nineteenth resistor 83, a tenth capacitor 84, a transistor 85 and a twentieth resistor 86. The auto-detecting/activating unit 80 serves to automatically detect/activate the circuit structure of the present invention. This will be further described hereinafter.

The relay 90 can be a mechanical-type relay or an electronic-type relay. In this embodiment, the relay 90 is a phototriac (also so-called “optocoupler triac”) under Model No. MOC3023. One terminal of the relay 90 via a 21st resistor 92 is connected to the contact 14 of the comparator 62 of the operation unit 60. The other terminal of the relay 90 is connected to the light modulation control unit 50. The relay 90 serves to provide an on/off control effect between the light modulation control unit 50 and the operation unit 60.

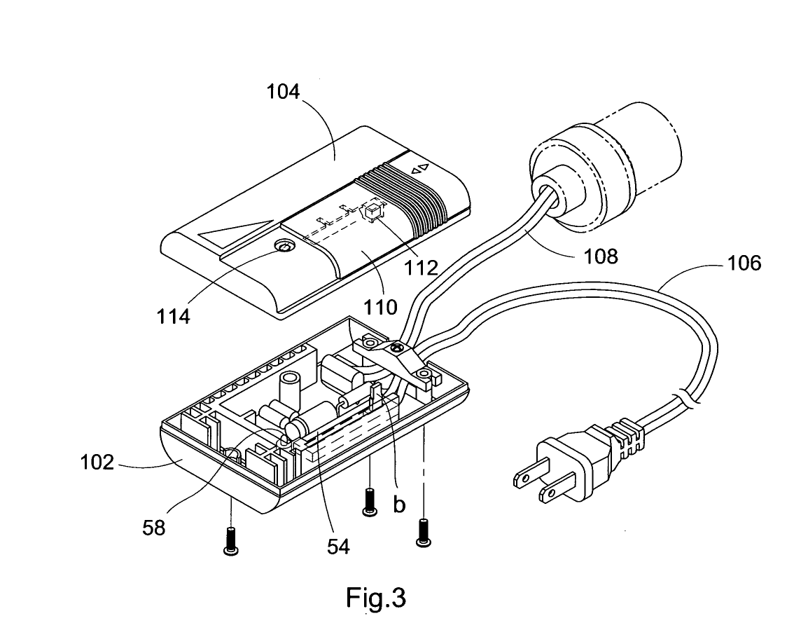

The circuit device can be made as the override protection switch 100 as shown in FIGS. 2 and 3. The switch includes a lower casing 102 and an upper casing 104. The circuit device of the present invention is made on a circuit board mounted between the upper and lower casings. FIG. 3 shows several electronic elements on the circuit board, such as the aforesaid indicator lamp (neon lamp) 58 and the second variable resistor 54. A power cable 106 and a load wire 108 are connected with the circuit board. The load wire is connectable to a bulb. A slidable shift button 110 is mounted on the upper casing 104. A bottom face of the shift button 110 is formed with a recessed fitting section 112 in which a controlling bar b of the variable resistor 54 is fitted for adjusting the output power. The upper casing 110 is formed with a transparent window 114 corresponding to the indicator lamp 58, whereby a user can see the indicator lamp 58.

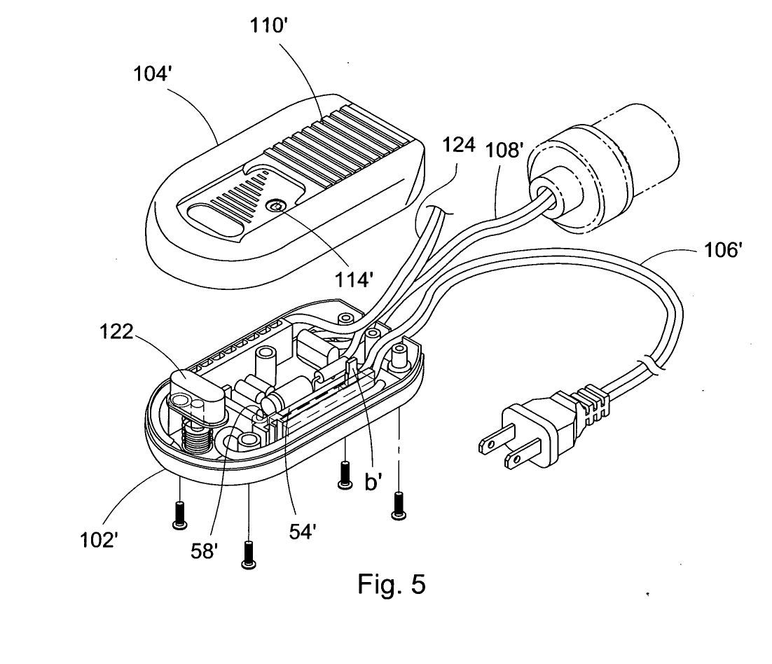

The circuit device can be also made as the override protection switch 120 as shown in FIGS. 4 and 5. The same components of the switch 120 are denoted with the same reference numerals and will not be repeatedly described. An on/off switch 122 is further disposed on the circuit board of the switch 120 and parallelly connected with the circuit device of the present invention. The switch 122 is not controlled by the circuit device of the present invention. An on/off switch cable 124 is further connected with the circuit board and connected to a switch of the lamp.

The operation of the present invention is described hereinafter. The circuit device of the present invention is applicable to a light to achieve a current-limiting effect and provide a nominal power such as 190 watts. (This is not limited). In the case that the load power of the bulb is smaller than the nominal value, the bulb is lighted and the circuit works normally. In the case that the load power of the bulb is over the nominal value, the present invention provides a reminding effect. The bulb will flicker to remind a user that the load power of the bulb exceeds the nominal value and it is necessary to replace the bulb or lower the power.

In the case that the load power is lower than the nominal value, for example, a bulb under 180 watts is used, after powered by the AC power supply, the first set of operation amplifier of the comparator 62 of the operation unit 60 will compare the voltage. In loaded state, the voltage-dividing sampling section 46 of the load voltage sampling unit 40 obtains a load voltage and inputs the load voltage into the contact 3 of the comparator 62. The load voltage is compared with the standard comparison voltage 76 connected to the contact 2 of the comparator 62. The load is within the nominal working range of the circuit so that the first set of operation amplifier of the comparator 62 will compare the voltage of the contact 3 with the voltage of the contact 2 to find that the voltage of the contact 3 is lower than the voltage of the contact 2. Under such circumstance, the circuit device 10 is in a normal working state and the contact 14 of the comparator 62 outputs high potential to energize the relay 90 and close the circuit. Therefore, the bulb A is lighted up.

In normal working state, by means of shifting the shift button 110 of the switch 100 or 120, the impedance of the second variable resistor 54 is adjustable to modulate the light.

With respect to the light modulation control unit 50, the power supply via the seventh resistor 53 and the second variable resistor 54 charges the seventh capacitor 57. When the charging voltage of the seventh capacitor 57 is greater than 30˜39 volts, the diac 56 is energized to energize the triac 52 via the eighth resistor 55. The size of the energizing angle of the triac 52 is variable by means of adjusting the second variable resistor 54 to control the charging rate of the seventh capacitor 57. Accordingly, the energizing time of the triac 52 at any semi-period is changeable to modulate the light.

The serially connected indicator lamp 58 and the ninth resistor 59 are parallelly connected with the contacts 1, 2 of the triac 52 to serve as a nightlight. Only when the triac 52 is not energized or low energized, the indicator lamp 58 will be lighted up. In the case that the triac 52 is high energized or fully energized, the voltage of the contacts 1, 2 thereof is low so that the indicator lamp 58 will not be lighted up. Another effect of the indicator lamp 58 and the ninth resistor 59 is to reduce the wave voltage of the triac 52 so as to avoid damage thereof. The inductor 51 is a wave-filtering inductor.

When the circuit works normally, the contact 8 of the comparator 62 is in a low potential state and will not energize the transistor 85 of the auto-detecting/activating unit 80

When the load of the bulb exceeds the nominal working range, for example, the power of the bulb is higher than 190 watts, and the second variable resistor 54 has a lowest impedance, that is, the shift button 110 is positioned in the brightest position, after powered on, the bulb will be turned on for a moment and then extinguished. This tells the user that it is overload. The lighting time of the bulb is determined by the exceeding wattage. The more the exceeding wattage is, the shorter the lighting time is. The operation of the circuit is as follows:

In the case of override bulb, the first set of operation amplifier of the comparator 62 will compare the voltage of the contact 3 with the voltage of the contact 2 to find that the voltage of the contact 3 is higher than the voltage of the contact 2. Under such circumstance, the output terminal of the first set of operation amplifier, that is, the contact 1, outputs high potential into the contact 5 of the comparator. After compared by the second set of operation amplifier of the comparator 62, the contact 7 outputs high potential into the contact 10. Then, after compared by the third set of operation amplifier of the comparator 62, the contact 8 outputs high potential into the contact 13. After compared by the fourth set of operation amplifier of the comparator 62, the contact 14 outputs no voltage (or low potential) to switch off the relay 90. At this time, the triac 52 loses its triggering voltage and is switched off to open the circuit. Therefore, the bulb will be turned on for a moment and then extinguished.

In the case of override, the auto-detecting/activating unit 80 will be automatically activated to operate. As aforesaid, in override, the contact 8 of the comparator 62 will output high potential to make the nineteenth resistor 83 of the auto-detecting/activating unit 80 charge the tenth capacitor 84. When the charging voltage is great enough to energize the transistor 85, the current of vcc voltage goes through the twentieth resistor 86 and the transistor 85 to the contact 6 of the comparator 62 so as to forcedly convert the comparator from the override state into the normal working state. At this time, the contact 8 of the comparator turns from high potential into low potential. The voltage of the tenth capacitor 84 is discharged via the eighteenth resistor 82 and the eighth diode 81 to switch off the transistor 85. Accordingly, the entire circuit is restored to its normal state.

Several seconds after the circuit is switched off due to the override protection (the duration is determined by the charging/discharging time of the tenth capacitor 84), the circuit is restored to the normal state and automatically detects the load. In the case that the load bulb is not replaced or the load power is not lowered, the circuit will again detect the override state. Under such circumstance, the above procedure will be repeated to again switch off the circuit. Therefore, in the case that the override state is not obviated, the circuit will repeatedly operate between the override state and the normal state. Accordingly, the bulb will periodically flicker to tell the user that the bulb is an override one.

During this procedure, in the case that the user lowers the load under the nominal power, for example, replaces the override bulb with a new one with lower power or shifts the shift button 110 to lower the power, at the next operation period, the circuit will automatically restore to the normal working state. At this time, the contact 14 of the comparator 62 is restored to output high potential to light up the bulb.

In addition, before the circuit restores to the normal state, the seventh diode 75 provides a feedback effect to keep the contacts 5, 8 and 13 of the comparator all at high potential and keep the contact 14 without voltage output. Accordingly, the relay 90 is kept disenergized.

Moreover, the negative electrode of the fifth diode 64 is connected to the contact 2 of the comparator 62 for compensating the temperature coefficient. This is because under the affection of the temperature, the fourth resistor 41, the fifth resistor 44, the second variable resistor 45, the sixth resistor 48 and the sixth capacitor 47 will make the voltage of the contact 3 of the comparator 62 slightly rise. When the voltage of the contact 3 rises, due to the principle that the rise of the temperature will lead to drop of pull-down, the fifth diode 64 will make the voltage of the contact 2 of the comparator simultaneously rise. Accordingly, the circuit will not be affected by the temperature.

By means of the present invention, a user can easily judge whether the power of the bulb exceeds the nominal value and whether the bulb is used in condition of high load power. In the case that the load power of the bulb exceeds the nominal value, before the user lowers the load power, the circuit device will repeatedly automatically detect the load power to make the bulb regularly flicker so as to tell the user to replace the bulb or lower the power. Once the load power is lowered to be within the range of the nominal value, the circuit device will restore to the normal working state.

The above embodiments are only used to illustrate the present invention, not intended to limit the scope thereof. Many modifications of the above embodiments can be made without departing from the spirit of the present invention. For example, the relay of the above embodiment can be replaced with an electromagnetic relay. In accordance with the type of the relay, the contact 14 of the comparator can output high potential to energize the relay or output no voltage to energize the relay.

What is claimed is:

1. An override protection circuit device with a bulb as a load, whereby in the case that the power of the bulb is within a nominal load power range, the bulb can be normally used, while in the case that the power of the bulb exceeds the nominal power, the circuit will be opened due to override; the circuit device comprising:
an operation unit including a comparator and a standard comparison voltage, the comparator serving to compare a voltage with the standard comparison voltage, the standard comparison voltage being connected to the comparator;
a rectifying/stabilizing unit, an input terminal of the rectifying/stabilizing unit being connected to an AC power source, while an output terminal of the rectifying/stabilizing unit being connected to the operation unit for providing necessary DC current for circuit;
a load voltage sampling unit having a voltage-dividing sampling section for obtaining a load sampling voltage, the output terminal of the voltage-dividing sampling section being connected to the comparator of the operation unit, whereby the comparator can compare the load sampling voltage with the standard comparison voltage;
a relay, one terminal of the relay being connected to the operation unit, while the other terminal of the relay being connected to the output terminal of the circuit device, a signal output terminal of the comparator of the operation unit being connected to the relay, whereby in the case that the load sampling voltage is smaller than the standard comparison voltage, the comparator works normally to output a signal to keep the relay energized, while in the case that the load sampling voltage is higher than the standard comparison voltage, the comparator is in an override state to output a signal to switch off the relay; and
an auto-detecting/activating unit connected to the operation unit, whereby when the comparator is in an override state, the auto-detecting/activating unit makes the comparator restore to the normal working state and in the case that the override state is not obviated, the auto-detecting/activating unit will periodically make the operation unit restore to the normal working state, whereby the load bulb will regularly flicker until the override state is obviated.

2. The override protection circuit device as claimed in claim 1, further comprising a light modulation control unit connected between the output terminal of the circuit device and the relay for modulating the power so as to adjust the output power of the circuit device.

3. The override protection circuit device as claimed in claim 1, wherein the auto-detecting/activating unit includes a charging/discharging element and a forward biased element, two terminals of the auto-detecting/activating unit being respectively connected to an input terminal and an output terminal of the comparator, whereby when the comparator is in an override state, the output terminal of the comparator outputs high potential to the auto-detecting/activating unit to charge the auto-detecting/activating unit which transmits voltage to the comparator so as to restore the comparator from the override state to the normal working state, after the comparator restores to the normal working state, the charging/discharging element of the auto-detecting/activating unit discharges to switch off the forward biased element.

4. The override protection circuit device as claimed in claim 2, wherein the auto-detecting/activating unit includes a charging/discharging element and a forward biased element, two terminals of the auto-detecting/activating unit being respectively connected to an input terminal and an output terminal of the comparator, whereby when the comparator is in an override state, the output terminal of the comparator outputs high potential to the auto-detecting/activating unit to charge the auto-detecting/activating unit which transmits voltage to the comparator so as to restore the comparator from the override state to the normal working state, after the comparator restores to the normal working state, the charging/discharging element of the auto-detecting/activating unit discharges to switch off the forward biased element.

5. The override protection circuit device as claimed in claim 1, wherein the value of the load sampling voltage obtained by the voltage-dividing sampling section of the load voltage sampling unit is adjustable.

6. The override protection circuit device as claimed in claim 5, wherein the voltage-dividing sampling section is composed of a resistor and a variable resistor.

7. The override protection circuit device as claimed in claim 2, wherein the value of the load sampling voltage obtained by the voltage-dividing sampling section of the load voltage sampling unit is adjustable.

8. The override protection circuit device as claimed in claim 1, wherein in the operation unit comprises two serially connected resistors, a contact between the two resistors serves as the standard comparison voltage.

9. The override protection circuit device as claimed in claim 1, wherein the operation unit further includes a diode connected between an input terminal and an output terminal of the comparator for providing a feedback effect, whereby in the case of override, the relay is kept switched off.

10. The override protection circuit device as claimed in claim 2, wherein the operation unit further includes a diode connected between an input terminal and an output terminal of the comparator for providing a feedback effect, whereby in the case of override, the relay is kept switched off.

11. The override protection circuit device as claimed in claim 2, wherein the light modulation control unit includes a variable impedor, a diac and a triac, the light modulation control unit further includes an indicator lamp, two terminals of the indicator lamp being connected to two terminals of the triac.

12. The override protection circuit device as claimed in claim 1, wherein the operation unit further includes a diode connected to an input terminal of the comparator for providing temperature compensating effect.

13. The override protection circuit device as claimed in claim 1, wherein the nominal power is not over 190 wattages.
